(19) United States
(12) Patent Application Publication
(10) Pub. No.: US 2003/0141128 A1
(43) Pub. Date: Jul. 31, 2003

(54) Method and system for controlling and/or regulating the handling characteristics of a motor vehicle

(76) Inventors: Ulrich Hessmert, Schwieberdingen (DE); Jost Brachert, Ditzingen (DE); Thomas Sauter, Remseck (DE); Helmut Wandel, Markgroeningen (DE); Norbert Polzin, Zaberfeld (DE)

Correspondence Address: KENYON & KENYON, ONE BROADWAY, NEW YORK, NY, 10004, US

(21) Appl. No.: 10/220,392

(22) PCT Filed: Dec. 21, 2001
(86) PCT No.: PCT/DE01/04859

(30) Foreign Application Priority Data
Dec. 30, 2000 (DE) 10065775.3
May 10, 2001 (DE) 10122653.5

(51) Int. Cl. B60K 17/34

(52) U.S. Cl. 180/233

(57) ABSTRACT

A method of controlling and/or regulating the driving response of a motor vehicle, in particular a vehicle having all-wheel drive, having at least two driven wheels, is described, at least one sensor element of a sensor (SVL, SVR, SHL, SHR) being provided on the wheels, in particular on the wheel bearings, and/or in the tires (RVL, RVR, RHL, RHR) assigned to the wheels, and the output signals of the sensors (SVL, SVR, SHL, SHR) being analyzed to control and/or regulate the driving response of the vehicle.

This method includes the following steps:

a) detecting forces acting on the wheels and/or tires (RVL, RVR, RHL, RHR) by the sensors (SVL, SVR, SHL, SHR);

b) determining a reference speed (FZ_REF) which represents the longitudinal speed of the vehicle, taking into account the forces acting on the wheels and/or the tires (RVL, RVR, RHL, RHR); and

c) taking into account the reference speed (FZ_REF) in controlling and/or regulating the driving response.

The present invention relates to a method of controlling and/or regulating-the driving response of a motor vehicle, in particular a vehicle having all-wheel drive, at least two wheels being driven, at least one sensor element of a sensor being situated on the wheels, in particular on the wheel bearings and/or in the tires on the wheels, and the output signals of the sensors for controlling and/or regulating the driving response of the vehicle being analyzed. In addition, the present invention relates to a system for controlling and/or regulating the driving response of a vehicle, in particular a vehicle having all-wheel drive, at least two wheels being driven, at least one sensor element of a sensor being provided on the wheels, in particular on the wheel bearings and/or in the tires on the wheels, and the output signals of the sensors being analyzed for controlling and/or regulating the driving response of the vehicle. The present invention also relates to a system for controlling and/or regulating the driving response of a vehicle having all-wheel drive and at least two tires and/or two wheels.

### BACKGROUND INFORMATION

The generic method and generic systems are used, for example, in conjunction with traction control or vehicle dynamics control systems. It is known that the wheel speeds of the individual wheels of a vehicle may be detected by sensors, and the detected wheel speeds taken into account in controlling and/or regulating the driving response of the vehicle. Although very good results have been achieved with the known methods and systems, there is interest in further improving the generic methods and systems, in particular with regard to traffic safety.

In conjunction with the generic sensors, it is also known that various tire manufacturers are planning in the future to use intelligent tires, where new sensors and analyzer circuits may be mounted directly on the tire. Use of such tires will allow additional functions such as measurement of the torque acting on the tire transversally and longitudinally to the direction of travel, the tire pressure or tire temperature. In this connection, for example, tires in which magnetized surfaces incorporated into each tire can be provided, i.e., strips having field lines running preferentially in the circumferential direction. The magnetization may be in sections, for example, always in the same direction but with opposing orientation, i.e., alternating polarity. The magnetized strips preferably run near the rim flange and near the tread. Therefore, these transducers rotate at wheel speed. Suitable measured value pickups are preferably mounted fixedly on the vehicle body at two or more different points in the direction of rotation and are also at different radial distances from the axis of rotation. Therefore, an internal measurement signal and an external measurement signal are obtained. Rotation of the tire may then be detected by the varying polarity of the measurement signal or signals in the circumferential direction. For example, the wheel speed may be calculated from the rolling circumference and the changes in the internal and external measurement signals over time.

### ADVANTAGES OF THE INVENTION

The method according to the present invention for controlling and/or regulating the driving response of a motor vehicle is based on the generic related art in that it includes the following steps:

a) detecting, via sensors the forces acting on the wheels and/or on the tires;

b) determining a reference speed representing the longitudinal speed of the vehicle, taking into account the forces acting on the wheels and/or tires, and

c) taking the reference speed into account in controlling and/or regulating the driving response.

Due to the fact that the forces acting on the wheels and/or tires, i.e., the torques derived therefrom, are taken into account in controlling and/or regulating driving response, it is possible to calculate a much more accurate reference speed required for optimum control and/or regulation of driving response. This is true in particular in conjunction with vehicles having all-wheel drive, so in this case it is a four-wheel reference speed. Due to the fact that a very accurate reference speed is taken into account in controlling and/or regulating driving response, this control and/or regulation may be implemented with better results in comparison with the related art. Furthermore, it is possible to detect wheel spinning and to keep the reference constant, in particular the four-wheel reference.

The method according to the present invention may also provide for wheel speeds detected by the sensors to be also taken into account in step b). Wheel speeds may be detected, for example, by the strips mentioned above being provided in each tire.

In preferred embodiments of the method according to the present invention, the wheel speeds detected by the sensors are ABS-filtered wheel speeds. In this way, the effects of an ABS which is preferably provided are taken into account.

The method according to the present invention may also provide for first PTl-filtered wheel speeds to be determined from the wheel speeds detected by the sensors. The first PTl filtering may be performed with a time constant of 80 ms, for example. In addition, the method according to the present invention may provide for second PTl-filtered wheel speeds to be determined from the wheel speeds detected by the sensors. The second PTl filtering may be performed with a time constant of 160 ms, for example.

In preferred embodiments of the method according to the present invention, it is additionally provided that wheel accelerations be taken into account in step b).

In this connection, the method according to the present invention may also provide for the wheel accelerations to be determined from the wheel speeds detected by the sensors. For example, it is possible to determine the wheel accelerations by forming a wheel difference, for which purpose the difference between the ABS-filtered wheel speed and the instantaneous wheel speed at the last computation cycle is determined. The time base of a computation cycle may be 20 ms, for example. The difference thus determined may then be PTl-filtered, e.g., with a time constant of 80 ms.

The method according to the present invention preferably additionally provides for the slowest wheel speed of the first filtered wheel speeds as well as the associated wheel acceleration to be taken into account in step b). This may be accomplished, for example, by applying comparison operations to the first filtered wheel speeds and the wheel accelerations.

The method according to the present invention may also provide that in step b) one or more of the following variables is taken into account: second-slowest wheel speed, average vehicle speed of the driven axles, greatest positive wheel acceleration, greatest negative wheel acceleration, greatest wheel speed. The second-slowest wheel speed may be determined, for example, by comparison operations applied to the second filtered wheel speeds. The average vehicle speed of the driven axles may be determined, for example, from the arithmetic mean of the first filtered wheel speeds. The greatest positive wheel acceleration corresponds to the maximum of the individual wheel accelerations. Similarly, the greatest negative wheel acceleration corresponds to the minimum of the individual wheel accelerations. The greatest wheel speed corresponds to the maximum of the individual wheel speeds and may be determined by comparison operations applied thereto.

The method according to the present invention may also provide for an unfiltered reference speed to be taken into account in step b). The unfiltered reference speed may then form an input variable for determination of the reference speed.

In this connection, the method according to the present invention may provide, for example, that, as a function of the selected determined variables, the unfiltered reference speed to be assigned the value of the greatest wheel speed, the value of the slowest wheel speed or the value of the average vehicle speed of the driven axles. This may take place as follows, for example: when the control and/or regulating device is initialized or when an engine torque corresponds to a zero engine torque, the unfiltered reference speed is assigned the value of the greatest wheel speed. Otherwise, in active control and/or regulation and if the slowest wheel speed is greater than a difference between the reference speed and predefined value (e.g., 1.38 m/s), the value of the slowest wheel speed is used for the unfiltered reference speed. If none of the query conditions explained above is met, a check is performed to determine whether the wheel acceleration of the slowest wheel is less than a predefined value (e.g., 0 m/s²). In this case, the unfiltered reference speed is assigned the value of the greatest wheel speed, and a REFL flag is set. If the wheel acceleration is greater than the value selected last (e.g., 0 m/s²), then the average vehicle speed of the driven axles is used when the REFL flag is set; otherwise, the REFL flag is reset, and the slowest wheel speed is used as the input variable for the unfiltered reference speed. The slowest wheel speed is also used if the REFL flag is not set.

The method according to the present invention provides for the forces acting on the wheels and/or tires to be taken into account according to step b) in the form of wheel pressures via wheel braking torques acting on the wheels and/or tires.

In this connection, the wheel braking torques are preferably also determined by multiplying the wheel pressures by a wheel coefficient.

The method according to the present invention may also provide for the sum of the wheel braking torques to be taken into account in step b). The sum of the braking torques may be used in particular to determine a theoretical longitudinal acceleration, as will be explained in greater detail below.

The method according to the present invention preferably also provides for the moments of inertia of the wheels as well as the sum of the moments of inertia of the wheels to be taken into account in step b). The sum of the moments of inertia of the wheels may also be used to determine a theoretical longitudinal acceleration by a method to be explained in greater detail below.

In addition, the method according to the present invention preferably provides for a drive torque which corresponds to the product of an instantaneous engine torque times a transmission and gear ratio to be taken into account in step b). The drive torque may also be used to determine the theoretical longitudinal acceleration by a method to be explained in greater detail below.

In addition, the method according to the present invention preferably provides for an air resistance moment to be taken into account in step b). The air resistance moment is determined as the product of an air resistance coefficient, the vehicle end face area, the air density, the rolling radius of the wheels, i.e., tires, and the square of the reference speed.

In the case of preferred embodiments of the method according to the present invention, the above-mentioned theoretical longitudinal acceleration is also determined as follows in step b:

$$ax\_model = \frac{MA - SumMBrake - MJ\_SUM - MWL}{R * m} ,$$

where MA denotes the drive torque, SumMBrake denotes the sum of the wheel braking torques, MJ_SUM denotes the sum of the moments of inertia of the wheels, MWL denotes the air resistance moment, R denotes the rolling radius of the wheels, i.e., tires, and m denotes the mass. This makes it possible, for example, to switch to the theoretical longitudinal acceleration when all the wheels are spinning, so that a much more accurate reference speed may be determined in comparison with the related art.

The method according to the present invention preferably also provides for detection of wheel spinning to be taken into account in step b). Determination of the wheel spinning detection and setting an ALLSLIP flag which characterizes the state in which all the wheels are spinning may take place as follows, for example: first, the rotational moment of inertia of the accelerating wheels (e.g., four) is determined on the basis of the calculated reference speed. To do so, a longitudinal acceleration which correlates with the reference speed is used by forming the difference between the instantaneous reference speed and the reference speed of the preceding cycle, the time base amounting to 20 ms, for example. The value of the rotational moment of inertia of the accelerating wheels, compared with the sum of all moments of inertia of the wheels, yields the moment of inertia of the driven wheels (four, for example) corrected by the reference speed. The setting of the ALLSLIP flag is controlled in this way. The ALLSLIP flag is set when the corrected moment of inertia of the wheel is greater than a predefined value (e.g., 100 Nm). To reset the ALLSLIP flag, a check is performed when the ALLSLIP flag is set to determine whether a counter is greater than a predefined value (e.g., 10). If this is the case, the counter is reset and the ALLSLIP flag is. This counter may be incremented by incrementing the counter by one in each cycle when the ALLSLIP flag is not set as long as the corrected moment of inertia of the wheels is in a predefined band (e.g., greater than −100 Nm and less than 100 Nm). If the corrected moment of inertia of the wheel is outside the band, the counter status remains unchanged.

The method according to the present invention preferably also provides for a reference gradient to be taken into account in step b).

In this connection, the method according to the present invention may also provide for the reference gradient to be selected from a plurality of predefined reference gradient values. This may take place as follows, for example. A selection is made from four different gradient limits for fitting the unfiltered reference speed to the reference speed. Furthermore, when wheel spinning is detected (ALLSLIP flag set), the fitting is performed on the basis of the theoretical longitudinal acceleration. There follows an explanation of the selection of the gradient limit having the highest priority. 1) When the difference between the greatest wheel speed and the slowest wheel speed is less than a predefined value (e.g., 2 m/s), and the greatest positive wheel acceleration is less than a predefined value (e.g., 6 m/s²) and the greatest negative wheel acceleration is less than a predefined value (e.g., 2.5 m/s²), then the value of a fourth predefined reference gradient is selected as the reference gradient (e.g., 0.194 m/s). 2) When the ALLSLIP flag is set, the product of the theoretical longitudinal acceleration times the time base, which may amount to 20 ms is selected as the gradient limit, for example. 3) If both rear axle wheels are being regulated, a second predefined reference gradient (e.g., 0.05 m/s) is selected as the reference gradient. 4) If no wheel is being regulated or if there is one wheel being regulated and its wheel braking torque is less than a parameter threshold value (e.g., 25 Nm), then a first predefined reference gradient value (e.g., 0.104 m/s) is selected. 5) If none of conditions 1) through 4) met, a third predefined reference gradient value (e.g., 0.104 m/s) is selected as the reference gradient. At a selected reference gradient, i.e., gradient limit, the reference speed may be determined as follows: if the difference between the unfiltered reference speed and the reference speed is greater than the reference gradient, the following is set: reference speed:=reference speed+reference gradient. If the difference between the unfiltered reference speed and the reference speed is less than a predefined value (e.g., −0.137 m/s) then the following is set: reference speed:=reference speed+predefined value (e.g., −0.137 m/s). If the two preceding conditions are not met, the following is set: reference speed:=unfiltered reference speed.

Each device for implementing the method according to the present invention falls within the scope of the associated claims.

The system according to the present invention for controlling and/or regulating driving response of a motor vehicle is based on the generic related art in that the sensors detect forces acting on the wheels and/or tires, and means are provided for determining a reference speed representing the longitudinal speed of the vehicle, this reference speed then being taken into account in controlling and/or regulating the driving response, the forces acting on the wheels and/or tires being taken into account in determination of the reference speed. Due to the fact that the forces acting on the tires and/or wheels, i.e., the torques derived therefrom, are taken into account in controlling and/or regulating driving response in the method according to the present invention, it is possible to calculate a significantly more accurate reference speed, which is necessary for optimum control and/or regulation of driving response. This is also true in this case in particular in conjunction with motor vehicles having all-wheel drive, so that in this case it may be a four-wheel reference speed. Due to the fact that a very accurate reference speed is taken into account in controlling and/or regulating driving response, the system according to the present invention may implement this control and/or regulation with better results in comparison with the related art. In addition, in conjunction with the system according to the present invention, it is possible to detect wheel spinning and to keep the reference, in particular the all-wheel reference constant.

In the system according to the present invention means for determining the reference speed representing the longitudinal speed of the vehicle should also preferably take into account the wheel speeds detected by the sensors. The wheel speeds may be determined, for example, by magnetic strips provided in each tire as mentioned above.

In this connection, the system according to the present invention preferably also provides for the wheel speeds detected by the sensors to be ABS-filtered wheel speeds. In this way, the effects of an ABS system which is preferably provided may also be taken into account by the system according to the present invention.

In preferred embodiments of the system according to the present invention the means for determining the reference speed representing the longitudinal speed of the vehicle additionally determine first PTl-filtered wheel speeds from the wheel speeds detected by the sensors. The first PTl filtering may also be performed here using a time constant of 80 ms, for example.

In addition, in conjunction with the system according to the present invention the means for determining the reference speed representing the longitudinal speed of the vehicle may also determine second PTl-filtered wheel speeds from the wheel speeds detected by the sensors. The second PTl filtering may be performed with a time constant of 160 ms, for example, as in the method according to the present invention.

In the case of the system according to the present invention, the means for determining the reference speed representing the longitudinal speed of the vehicle preferably also take into account wheel accelerations.

In this connection, the system according to the present invention preferably also provides for the means for determining the reference speed representing the longitudinal speed of the vehicle to determine the wheel accelerations from the wheel speeds detected by the sensors. As in the case of the method according to this invention, it is possible, for example, to determine the wheel accelerations by a particular wheel differentiation for which the difference between the ABS-filtered instantaneous wheel speed and the wheel speed of the most recent computation cycle is determined. Here again, the time base of a computation cycle may be 20 ms, for example. The difference thus determined may then be PTl-filtered, e.g., with a time constant of 80 ms.

In the case of the system according to the present invention, the means for determining the reference speed representing the longitudinal speed of the vehicle preferably also take into account the slowest wheel speed of the first filtered wheel speeds as well as the associated wheel acceleration. This may be accomplished, for example, by applying appropriate comparison operations to the first filtered wheel speeds as well as the wheel accelerations, as already explained in conjunction with the method according to the present invention. It is of course also possible to determine the particular wheel acceleration from the corresponding wheel speed values.

In conjunction with the system according to the present invention, the means for determining the reference speed representing the longitudinal speed of the vehicle also preferably take into account one or more of the following variables: second-slowest wheel speed, average wheel speed of the driven axles, greatest positive wheel acceleration, greatest negative wheel acceleration, greatest wheel speed. The second-slowest wheel speed may also be determined in this case, by comparison operations applied to the second filtered wheel speeds, for example. The average wheel speed of the driven axles may be determined, for example, from the arithmetic mean of the first filtered wheel speeds. The greatest positive wheel acceleration in turn corresponds to the maximum of the individual wheel accelerations. Similarly, the greatest negative wheel acceleration in turn corresponds to the minimum of the individual wheel accelerations. The greatest wheel speed corresponds to the maximum of the individual wheel speeds and may be determined by comparison operations applied thereto, as already explained in conjunction with the method according to the present invention.

In the case of the system according to the present invention, the means for determining the reference speed representing the longitudinal speed of the vehicle preferably also take into account an unfiltered reference speed.

In this connection, the system according to the present invention, like the method according to the present invention, preferably also provides for the means for determining the reference speed representing the longitudinal speed of the vehicle to assign the value of the greatest wheel speed, the value of the slowest wheel speed or the value of the average vehicle speed of the driven axles to the unfiltered reference speed as a function of selected determined variables. This may take place as follows, for example, as described in conjunction with the method according to the present invention: in initializing the controlling and/or regulating device or when an engine torque corresponds to a zero engine torque, the unfiltered reference speed is assigned the value of the greatest wheel speed. Otherwise, in active control and/or regulation and when the slowest wheel speed is greater than the difference between the reference speed and a predefined value (e.g., 1.38 m/s), the value of the slowest wheel speed is used for the unfiltered reference speed. If none of the query conditions mentioned above is met, a check is performed to determine whether the wheel acceleration of the slowest wheel is less than a predefined value (e.g., 0 M/s²). In this case the unfiltered reference speed is assigned the value of the greatest wheel speed, and a REFL flag is set. If the wheel acceleration is greater than the aforementioned predefined value (e.g., 0 m/s²), then the average vehicle speed of the driven axles is used when the REFL flag is set; otherwise the REFL flag is reset and the slowest wheel speed is used as the input variable for the unfiltered reference speed. The slowest wheel speed is also used when the REFL is not set.

In the system according to the present invention, the means for determining the reference speed representing the longitudinal speed of the vehicle preferably take into account the forces acting on the wheels and/or tires in the form of wheel pressures via wheel braking torques acting on the wheels and/or tires.

In addition, in the system according to the present invention, the means for determining the reference speed representing the longitudinal speed of the vehicle preferably also determine the wheel braking torques by multiplying the wheel pressures by a brake coefficient.

The system according to the present invention is preferably designed so that the means for determining the reference speed representing the longitudinal speed of the vehicle take into account the sum of the wheel braking torques. The sum of the braking torques may also be used here in particular for determining a theoretical longitudinal acceleration, as will be explained in greater detail below.

In addition, in the system according to the present invention it is also possible to provide for the means for determining the reference speed representing the longitudinal speed of the vehicle to take into account moments of inertia of the wheel as well as the sum of the moments of inertia of the wheels. The sum of the moments of inertia of the wheels may also be used in a manner to be explained in greater detail below to determine a theoretical longitudinal acceleration.

In the system according to the present invention, the means for determining the reference speed representing the longitudinal speed of the vehicle preferably also take into account a drive torque, which corresponds to the product of an instantaneous engine torque and a transmission and gearshift ratio. The drive torque may be used to determine the theoretical longitudinal acceleration, as already explained in conjunction with the method according to the present invention.

In the system according to the present invention the means for determining the reference speed representing the longitudinal speed of the vehicle preferably also take into account an air resistance moment. The air resistance moment is in turn determined as the product of an air resistance coefficient, the vehicle end face area, the air density, the rolling radius of the wheels, i.e., tires, and the square of the reference speed.

In the case of preferred embodiments of the system according to the present invention, the means for determining the reference speed representing the longitudinal speed of the vehicle determine the above-mentioned theoretical longitudinal acceleration as follows:

$$ax\_model = \frac{MA - SumMBrake - MJ\_SUM - MWL}{R * m} ,$$

where MA denotes the drive torque, SumMBrake denotes the sum of the wheel braking torques, MJ_SUM denotes the sum of the moments of inertia of the wheels, MWL denotes the air resistance moment, R denotes the rolling radius of the wheels, i.e., tires., and m denotes the mass. This makes it possible to switch to the theoretical longitudinal acceleration, for example, when all the wheels are spinning, so that it is possible to determine a much more accurate reference speed in comparison with the related art, as already explained in conjunction with the method according to the present invention.

In the preferred embodiments of the system according to the present invention, the means for determining the reference speed representing the longitudinal speed of the vehicle also take into account the detection of wheel spinning. The determination of wheel spinning detection and the setting of an ALLSLIP flag which characterizes the state in which all the wheels are spinning may also take place as follows in this case: first, the rotational moment of inertia of the (e.g., four) accelerating wheels is determined on the basis of the calculated reference speed. To do so, again a longitudinal acceleration which correlates with the reference speed is used by forming the difference between the instantaneous reference speed and the reference speed of the preceding cycle, the time base again corresponding to 20 ms, for example. The value of the rotational moment of inertia of the accelerating wheels, compared with the sum of all the moments of inertia of the wheels, yields the moment of inertia of the (e.g., four) driving wheels corrected by the reference speed. Thus, again the setting of the ALLSLIP flag is controlled. The ALLSLIP flag is set when the corrected moment of inertia of the wheels is greater than a predefined value (e.g., 100 Nm). To reset the ALLSLIP flag, a check is performed when the ALLSLIP flag is set to determine whether a counter is greater than a predefined value (e.g., 10). If this is the case, the counter is reset and the ALLSLIP flag is. This counter may also be incremented here by incrementing the counter by one in each cycle when the ALLSLIP flag is not set as long as the corrected moment of inertia of the wheels is in a preselected band (e.g., greater than −100 Nm and less than 100 Nm). If the corrected moment of inertia of the wheels is outside this band, the counter status remains unchanged.

In addition, in the preferred embodiments of the system according to the present invention, the means for determining the reference speed representing the longitudinal speed of the vehicle take into account a reference gradient, as already explained in conjunction with the method according to the present invention.

In this connection, in the system according to the present invention, the means for determining the reference speed representing the longitudinal speed of the vehicle preferably also select the reference gradient from a plurality of predefined reference gradient values. This may be implemented as follows, for example. A selection is made from four different gradient limits for fitting the unfiltered reference speed to the reference speed. Furthermore, when wheel spinning is detected (ALLSLIP flag set), fitting is implemented via the theoretical longitudinal acceleration. The selection of the gradient limit having the highest priority may be made as described in the case of the method according to the present invention. 1) If the difference between the greatest wheel speed and the slowest wheel speed is less than a predefined value (e.g., 2 m/s) and the greatest positive wheel acceleration is less than a predefined value (e.g., 6 m/s²) and the greatest negative wheel acceleration is less than a predefined value (e.g., 2.5 M/s²), then the value of a fourth predefined reference gradient is selected as the reference gradient (e.g., 0.194 m/s). 2) When the ALLSLIP flag is set, the product of the theoretical longitudinal acceleration multiplied by the time base is selected as the gradient limit and may amount to 20 ms, for example. 3) If both rear axle wheels are being regulated, a second predefined reference gradient (e.g., 0.05 m/s) is selected as the reference gradient. 4) If no wheel is being regulated or exactly one wheel is being regulated and its wheel braking torque is less than a parameter threshold value (e.g., 25 Nm), then a first predefined reference gradient value (e.g., 0.104 m/s) is selected. 5) If none of conditions 1) through 4) is met, a third predefined reference gradient value (e.g., 0.104 m/s) is selected as the reference gradient. In the case of a selected reference gradient, i.e., gradient limit, the reference speed may be determined as follows: if the difference between the unfiltered reference speed and the reference speed is greater than the reference gradient, the following is set: reference speed:=reference speed+reference gradient. If the difference between the unfiltered reference speed and the reference speed is less than a predefined value (e.g., −0.137 m/s), the following is set: reference speed:=reference speed +predefined value (e.g., −0.137 m/s). If the two preceding conditions are not met, the following is set: reference speed :=unfiltered reference speed.

Another embodiment of the system according to the present invention for controlling and/or regulating driving response of a vehicle having all-wheel drive is based on the generic related art in that a force sensor is mounted in the tires or on the wheels, in particular on the wheel bearings, and a reference speed variable representing the longitudinal speed of the vehicle is determined as a function of the output signals of the force sensor, and this reference speed variable is taken into account in controlling and/or regulating the driving response. Due to the fact that the longitudinal speed of the vehicle is determined as a function of the output signals of the force sensor, it is possible to calculate a much more accurate four-wheel reference speed. An accurate all-wheel reference speed is especially important in controlling and/or regulating driving response of an all-wheel vehicle. With the additional embodiment of the system according to the present invention for controlling and/or regulating the driving response of a motor vehicle having an all-wheel drive, it is also possible to achieve better results in controlling and/or regulating the driving response in comparison with the related art.

### DRAWING

The present invention is explained in greater below on the basis of the respective drawing.

FIG. 1 A schematic diagram of an embodiment of the system according to the present invention, this system also being suitable for implementing the method according to the present invention;

FIG. 2 a schematic diagram of a sensor in the form of a side-wall sensor which may be used in conjunction with the present invention;

FIG. 3 an example of the output signals of the sidewall sensor illustrated in FIG. 2, and

FIG. 4 a block diagram of an embodiment of means for determining a reference speed representing the longitudinal speed of the vehicle, these means also being suitable for implementing the characterizing steps of the method according to the present invention.

### DETAILED DESCRIPTION OF THE EXEMPLARY EMBODIMENTS

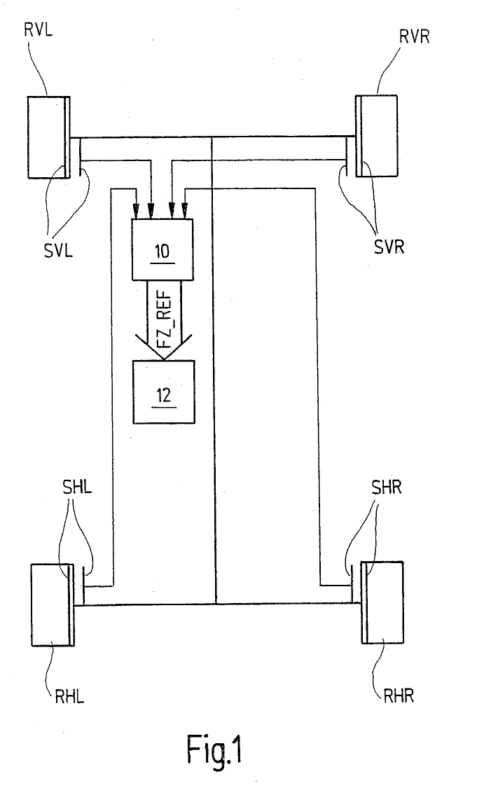

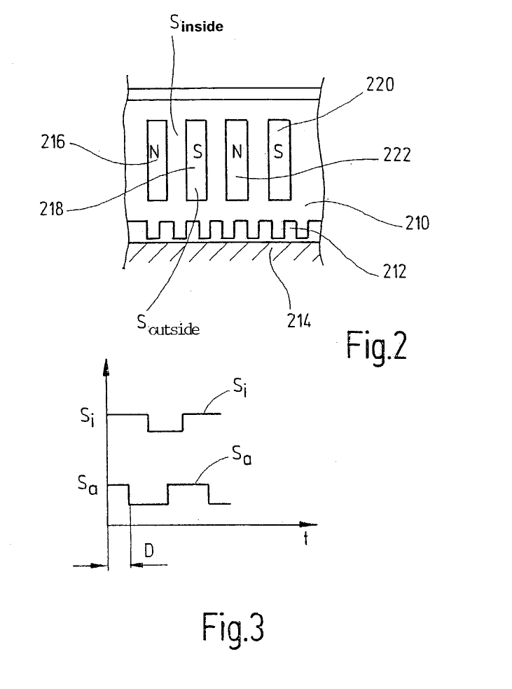

FIG. 1 shows a schematic diagram of an embodiment of the system according to the present invention. According to the diagram in FIG. 1, a sensor SVL, SVR, SHL and SHR, respectively, is assigned to a left front tire RVL, a right front tire RVR, a left rear tire RHL and a right rear tire RHR. In the embodiment illustrated here, sensors SVL, SVR, SHL and SHR are formed by side-wall sensors, as explained in greater detail below on the basis of FIGS. 2 and 3. However, the present invention is not limited to sensors having sensor elements in the tires but in addition or as an alternative it is also possible to use sensors in which at least one sensor element is provided on the wheels, in particular on the wheel bearings. Sensors SVL, SVR, SHL, SHR shown here supply signals which are sent to means 10 for determining a reference speed FZ_REF representing the longitudinal speed of the vehicle. The signals sent to means 10 for determining a reference speed representing the longitudinal speed of the vehicle may optionally be processed by circuits assigned to sensors SVL, SVR, SHL, SHR. Means 10 output reference speed FZ_REF thus determined to a unit 12 which controls and/or regulates the driving response of the vehicle. Although means 10 for determining reference speed FZ_REF representing the longitudinal speed of the vehicle are shown in FIG. 1 as being separate from device 12, it is clear that means 10 and device 12 may optionally also be formed by a single module.

FIG. 2 shows a schematic diagram of a sensor in the form of a side-wall sensor which may be used in conjunction with the present invention. According to the diagram in FIG. 2, magnetized strips 216, 218, 220, 222 having field lines running in the circumferential direction are incorporated into a tire 210, which is illustrated only in sections and whose profile 212 is indicated only schematically. Magnetized strips 216, 218, 220, 222 in sections are always magnetized in the same direction but with the opposite orientation, i.e., with alternating polarity. Magnetized strips 216, 218, 220, 222 run in the rim flange and the tread. Transducers 216, 218, 220, 222 thus rotate at wheel speed. Two measured value pickups S_{inside}, S_{outside} are mounted fixedly on the vehicle body at two different points in the direction of rotation and are at different radial distances from the axis of rotation.

FIG. 3 shows an example of output signals Sᵢ, Sₐ of the side-wall sensor illustrated in FIG. 2, signal Sᵢ being assigned to measured value pickup S_{inside} and signal Sₐ being assigned to measured value pickup S_{outside}. For example, the wheel speed may be determined from the frequency of signals Sᵢ, Sₐ, while deformation, i.e., torsion of the tire and thus the forces acting on the wheels and/or tires, can be determined from the mutual position of signals Sᵢ, Sₐ.

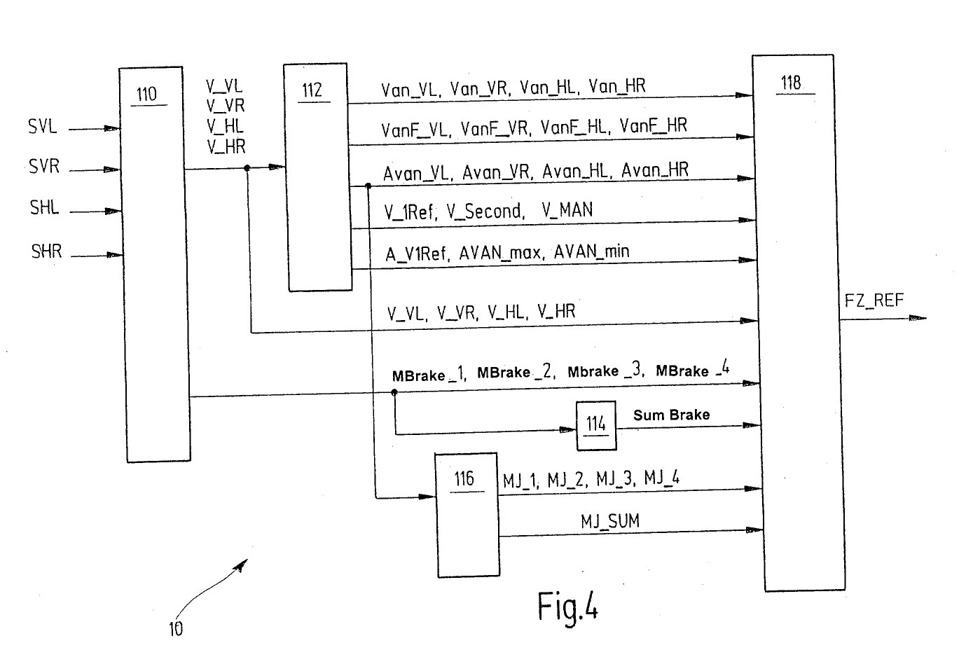

FIG. 4 shows a block diagram of an embodiment of means for determining a reference speed representing the longitudinal speed of the vehicle, these means also being suitable for implementation of the characterizing step of the method according to the present invention. The following explanation of a special embodiment of the invention pertains to a vehicle having four wheels and all-wheel drive. As explained, however, the present invention is not limited to such a vehicle.

According to FIG. 4, a function block 110 is provided, receiving the signals from sensors SVL, SVR, SHL and SHR. Function block 110 may also be formed by several circuits provided for individual sensors SVL, SVR, SHL and SHR.

The following description of the functioning of the system illustrated in FIG. 4 is provided in the following sections to facilitate an understanding:

I. SIGNAL PROCESSING AND FILTERING OF THE WHEEL SPEEDS

II. DETERMINING THE SLOWEST WHEEL SPEED V_1Ref AND THE ASSOCIATED WHEEL ACCELERATION A_V1Ref

III. DETERMINING ADDITIONAL SPEED AND ACCELERATION VARIABLES

IV. DETERMINING UNFILTERED REFERENCE SPEED FZ_REF_un AS AN INPUT VARIABLE FOR DETERMINING REFERENCE SPEED FZ REF

V. BALANCE OF TORQUES

VI. DETERMINATION OF WHEEL SPINNING DETECTION AND SETTING THE ALLSLIP FLAG

VII. SELECTING THE REFERENCE GRADIENT FOR ADAPTING REFERENCE SPEED FZ_REF

### I. SIGNAL PROCESSING AND FILTERING OF THE WHEEL SPEEDS

The ABS-filtered (ABS=anti-lock brake system) wheel speeds V_VL, V_VR, V_HL and V_HR output by function block 110 are processed further by a function block 112. This function block 112 is provided among other things for PTl filtering of ABS-filtered wheel speeds V_VL, V_VR, V_HL and V_HR with a time constant of 80 ms and determining first filtered wheel speeds Van_VL, Van_VR, Van_HL and Van_HR from these results.

Function block 112 is also provided for PTl filtering ABS-filtered wheel speeds V_VL, V_VR, V_HL and V_HR with a time constant of 160 ms, thereby yielding second filtered wheel speeds VanF_VL, VanF_VR, VanF_HL and VanF HR.

To form the wheel difference, the difference between the ABS wheel speed in the current and the last computation cycle (time base 20 ms) is used and is PTl-filtered with a time constant of 80 ms. This results in wheel differentiation variables, i.e., wheel accelerations Avan VL, Avan_VR, Avan_HL, Avan_HR.

ABS-filtered wheel speeds V_VL, V_VR, V_HL and V_HR, first filtered wheel speeds Van_VL, Van_VR, Van_HL, second filtered wheel speeds VanF_VL, VanF_VR, VanF_HL and VanF_HR and wheel accelerations Avan_VL, Avan_VR, Avan_HL and Avan_HR are sent from function block 110 and function block 112 to function block 118 respectively, function block 118 taking these variables into account in determining the reference speed.

### II. DETERMINATION OF SLOWEST WHEEL SPEED V_1Ref AND ASSOCIATED WHEEL ACCELERATION A_V1Ref

Function block 112 determines a slowest wheel speed of wheel speeds Van_VL, Van_VR, Van_HL and Van_HR and assigns it to variable V_1Ref. Furthermore, function block 112 assigns the wheel acceleration of this wheel to variable A_V1Ref.

Function block 112 sends slowest wheel speed V_1Ref and respective wheel acceleration A_V1Ref to function block 118 so that the latter may also take these variables into account in determining reference speed FZ_REF.

### III. DETERMINING ADDITIONAL SPEED AND ACCELERATION VARIABLES

Function block 112 determines the second-slowest wheel speed V_Second from wheel speeds VanF_VL, VanF_VR, VanF HL and VanF_HR filtered with 160 ms.

Average vehicle speed VMAN of the driven axles is determined by function block 112 from the arithmetic mean of the four individual wheel speeds Van_VL, Van_VR, Van HL and Van_HR.

The largest positive wheel acceleration is the maximum of the four individual accelerations Avan_VL, Avan_VR, Avan HL and Avan_HR and is designated as Avan_max.

The greatest negative wheel acceleration is the minimum of the four individual wheel accelerations Avan_VL, Avan VR, Avan_HL and Avan_HR and is designated as Avan_min.

Furthermore, function block 112 also forms a greatest wheel speed VANmax from the four individual wheel speeds Van_VL, Van_VR, Van_HL and Van_HR.

Function block 112 sends second-slowest wheel speed V_Second, the average vehicle speed of the driven axles VMAN, greatest positive wheel acceleration Avan_max, greatest negative wheel acceleration AVAN_min and greatest wheel speed VANmax to function block 118 so that the latter may also take these variables into account in determining reference speed FZ_REF.

### IV. DETERMINING UNFILTERED REFERENCE SPEED FZ_REF_un AS AN INPUT VARIABLE FOR DETERMINING REFERENCE SPEED FZ_REF

a) When initializing the control device or at engine torque=zero engine torque, VAN_max is assigned by function block 118 to variable FZ_REF.

b) Otherwise, V_1Ref is used by function block 118 in active regulation and with the query (V_Ref>FZ REF-#V_UMSCH).

If this query condition is not met, function block 118 performs a check to determine whether the wheel acceleration of slowest wheel A_V1Ref<#P_AGRENZ. In this case, VAN_max is assigned to FZ_REF_un and the REFL flag is set.

If the wheel acceleration is>#P_AGRENZ, when the REFL flag is set, the average speed VMAN at V_VIRef<0 is used; otherwise, the REFL flag is set, and V_1Ref is used as the input variable for the unfiltered vehicle reference. When the REFL flag is not set, V_1Ref is used.

Parameters used:

#V_UMSCHW: 1.38 m/s

#P_AGRENZ: 0 m/s²

### V. BALANCE OF TORQUES

Determining the Wheel Braking Torques:

The wheel pressure is determined from the side-wall sensor signal input. This multiplied by braking coefficient cp yields instantaneous wheel braking torque MBrake. Respective wheel braking torques MBrake_1, MBrake 2, MBrake_3, MBrake_4 are sent from function block 110 to function block 118.

The sum of all wheel braking torques SumMBrake is formed by a function block 114 and corresponds to the addition of all four individual wheel braking torques MBrake_i. The sum of all wheel braking torques SumMBrake is sent from function block 114 to function block 118.

SumMBrake=ΣMbrake_i, i=1,4

Determining Moments of Inertia of the Wheels MJ i:

Moments of inertia of the wheels MJ_1, MJ_2, MJ_3, MJ_4 are determined by a function block 116 as follows:

MJ_i=AVAN * Jwheel * Rwheel, i=1,4, where AVAN=Avan_VL, Avan_VR, Avan_HL, Avan_HR.

Function block 116 sends moments of inertia of the wheels MJ_1, MJ_2, MJ_3, MJ_4 to function block 118, so that the latter may also take these variables into account in determination of the reference speed.

Determining MJ SUM, the Sum of All Moments of Inertia of the Wheels:

Function block 116 also determines the sum of all moments of inertia of the wheels MJ_SUM from the moments of inertia of the wheels MJ_1, MJ_2, MJ_3, MJ_4.

MJ_SUM=ΣMJ_i, i=1,4

Variable MJ_SUM is also sent from function block 116 to function block 118.

Determining Drive Torque MA:

Drive torque MA is determined by function block 118 as the product of the instantaneous engine torque and the transmission and gearshift ratio.

Determining Air Resistance Moment MWL:

The air resistance moment is determined by function block 118 as the product of air resistance coefficient cw, vehicle end face area A, air density ρ, rolling radius R and the square of vehicle speed FZ_REF.

MWL=cw * A * ρ/2 * FZ_REF² * R

Determining the Theoretical Longitudinal Acceleration Ax:

Starting from the moment balance, a theoretical longitudinal acceleration ax is calculated in a function block 118:

$$ax\_model = \frac{MA - Σ MBrake\_i - Σ Mj\_i - Σ MWL}{R * m} ,$$

where MA denotes the drive torque, SumMBrake denotes the sum of the wheel braking torques (MBrake_1, MBrake_2, MBrake_3, MBrake_4), MJ_SUM denotes the sum of moments of inertia of the wheels (MJ_1, MJ_2, MJ_3, MJ_4), MWL denotes the air resistance moment, R denotes the rolling radius of the wheels, i.e., tires (RVL, RVR, RHL, RHR) and m denotes the mass.

### VI. DETERMINING THE WHEEL SPINNING DETECTION AND SETTING THE ALLSLIP FLAG

First the rotational moment of inertia of the four accelerating wheels is determined in function block 118 on the basis of the calculated vehicle reference FZ_REF. To do so, longitudinal acceleration A_FZ_REF is used by forming the difference between the instantaneous FZ_REF and FZ_REF of the preceding cycle (time base 20 ms).

→MJ_REF=A_FZ_REF * Jrad * Rrad * 4

This value, compared with the sum of all moments of inertia of the wheels MJ_SUM, yields the moment of inertia of the wheel MJ_Kor corrected by the vehicle reference for four driven wheels. Setting the ALLSLIP flag is controlled in this way.

→MJ_Kor=MJ_SUM-MJ_REF

Setting the ALLSLIP Flag:

The ALLSLIP flag is set when MJ_KOR>#P_FJSCHW.

Resetting the ALLSLIP Flag:

When the flag is set, a check is performed to determine whether the counter CNT_ALLSLIP>#P_RESET. If that is the case, the counter is reset and the flag is reserved.

Increment of Counter CNT ALLSLIP:

The counter is incremented by one in each cycle, if the ALLSLIP flag is not set, as long as MJ_KOR is within the band #P_FJSCHW<MJ_KOR<#P_FJSCHW.

If MJ_KOR is outside this band, the count remains unchanged.

Parameters Used:

#P_FJSCHW: 100 Nm

#P_RESET: 10

### VII. SELECTING THE REFERENCE GRADIENT FOR ADAPTING THE REFERENCE SPEED FZ_REF

In this embodiment, function block 118 selects from four different gradient limits for adapting unfiltered vehicle reference FZ_REF_un to vehicle reference FZ_REF. Furthermore, when wheel spinning is detected (ALLSLIP flag), adapting is performed via theoretical longitudinal acceleration ax.

Selection of the Gradient Limit Having the Highest Priority:

1) When ((VANmax-V_1Ref) #REF_HYS)

(AVANmax<#A_MAX)

(AVANmin<#A_MIN)

The max GRADIENT #REF_Gradient4 is selected.

2) When the ALLSLIP flag is set, the product of ax and time base DT (20 ms) is selected as the gradient limit.

3) If both rear axle wheels are regulated, #REF GRADIENT2 is determined.

4) If no wheel is being regulated or exactly one wheel is regulated and its wheel braking torque MBrake is less than parameter threshold #MBRAKESCHW, gradient #REF_Gradient1 is selected.

5) If none of conditions (1-4) is met, adapting is performed using #REF_GRADIENT3.

Parameters used:

#REF_HYS : 2 m/s

#REF_GRADIENTt1: 0.104 m/s

#REF_GRADIENT2: 0.05 m/s

#REF_GRADIENT3: 0.104 m/s

#REF_GRADIENT4: 0.194 m/s

#A_MIN 2.5 M/s²

#A_MAX: 6 M/s²

#MBRAKESCHW : 25 Nm

Determining Reference Speed FZ REF With a Selected Gradient Limit “REFGRADIENT”:

When ((FZ_REF_un-FZ_REF)>REFGRADIENT) →FZ_REF=FZ_REF+REFGRADIENT

When ((FZ_REF_un-FZ_REF)<#REFDOWN) →FZ_REF=FZ_REF+#REFDOWN

If the 2 conditions above are not met

→FZ_REF=FZ_REF_un

Parameters used:

#REFDOWN: −0.137

The preceding description of the exemplary embodiments according to the present invention is given only for illustrative purposes and not for the purpose of restricting the scope of the present invention. Various changes and modifications are possible as part of the present invention without going beyond the scope of the present invention or its equivalents.

What is claimed is:

1. A method of controlling and/or regulating the driving response of a motor vehicle, in particular a vehicle having all-wheel drive, having at least two driven wheels, at least one sensor element of a sensor (SVL, SVR, SHL, SHR) being provided on the wheels, in particular on the wheel bearings, and/or in the tires (RVL, RVR, RHL, RHR) assigned to the wheels, and the output signals of the sensors (SVL, SVR, SHL, SHR) being analyzed to control and/or regulate the driving response of the vehicle, wherein the method includes the following steps:
a) detecting forces acting on the wheels and/or tires (RVL, RVR, RHL, RHR) by the sensors (SVL, SVR, SHL, SHR),
b) determining a reference speed (FZ_REF) which represents the longitudinal speed of the vehicle, taking into account the forces acting on the wheels and/or tires (RVL, RVR, RHL, RHR), and
c) taking into account the reference speed (FZ_REF) in controlling and/or regulating the driving response.

2. The method as recited in claim 1, wherein wheel speeds (V_VL, V_VR, V_HL, V_HR) detected by the sensors (SVL, SVR, SHL, SHR) are also taken into account in step b).

3. The method as recited in one of the preceding claims, wherein the wheel speeds (V_VL, V_VR, V_HL, V_HR) detected by the sensors (SVL, SVR, SHL, SHR) are ABS-filtered wheel speeds.

4. The method as recited in one of the preceding claims, wherein first PTl-filtered wheel speeds (Van_VL, Van_VR, Van HL, Van_HR) are determined from the wheel speeds (V_VL, V_VR, V_HL, V_HR) detected by the sensors (SVL, SVR, SHL, SHR).

5. The method as recited in one of the preceding claims, wherein second PTl-filtered wheel speeds (VanF_VL, VanF_VR, VanF_HL, VanF_HR) are determined from wheel speeds (V_VL, V VR, V_HL, V_HR) detected by the sensors (SVL, SVR, SHL, SHR).

6. The method as recited in one of the preceding claims, wherein wheel accelerations (Avan_VL, Avan_VR, Avan_HL, Avan HR) are also taken into account in step b).

7. The method as recited in one of the preceding claims, wherein the wheel accelerations (Avan_VL, Avan_VR, Avan_HL, Avan_HR) are determined from the wheel speeds (V_VL, V_VR, V HL, V_HR) detected by the sensors (SVL, SVR, SHL, SHR).

8. The method as recited in one of the preceding claims, wherein the slowest wheel speed (V_1Ref) of the first filtered wheel speeds (Van_VL, Van_VR, Van_HL, Van_HR) and the respective wheel acceleration (A_V1Ref) are also taken into account in step b).

9. The method as recited in one of the preceding claims, wherein one or more of the following variables are taken into account in step b): second-slowest wheel speed (V_Second), average vehicle speed of the driven axles (VMAN), greatest positive wheel acceleration (AVAN_max), greatest negative wheel acceleration (AVAN_min), greatest wheel speed (VANmax).

10. The method as recited in one of the preceding claims, wherein an unfiltered reference speed (FZ_REF_un) is taken into account in step b).

11. The method as recited in one of the preceding claims, wherein the value of the greatest wheel speed (VANmax), the value of the slowest wheel speed (V_1Ref) or the value of the average vehicle speed of the driven axles (VMAN) is assigned to the unfiltered reference speed (FZ_REF_un) as a function of selected determined variables.

12. The method as recited in one of the preceding claims, wherein the forces acting on the wheels and/or tires (RVL, RVR, RHL, RHR) are taken into account according to step b) in the form of wheel pressures via wheel braking torques (MBrake 1, MBrake_2, MBrake_3, MBrake_4) acting on the wheels and/or tires (RVL, RVR, RHL, RHR).

13. The method as recited in one of the preceding claims, wherein the wheel braking torques (MBrake_1, MBrake_2, MBrake 3, MBrake_4) are determined by multiplying the wheel pressures by a brake coefficient (cp).

14. The method as recited in one of the preceding claims, wherein the sum (SumMBrake) of the wheel braking torques (MBrake_1, MBrake_2, MBrake_3, MBrake_4) is taken into account in step b).

15. The method as recited in one of the preceding claims, wherein the moments of inertia of the wheels (MJ_1, MJ_2, MJ 3, MJ_4) and the sum (MJ_SUM) of the moments of inertia of the wheels (MJ_1, MJ_2, MJ_3, MJ_4) are taken into account in step b).

16. The method as recited in one of the preceding claims, wherein a drive torque (MA) which corresponds to the product of an instantaneous engine torque and a transmission and gearshift ratio is taken into account in step b).

17. The method as recited in one of the preceding claims, wherein an air resistance moment (MWL) is taken into account in step b).

18. The method as recited in one of the preceding claims, wherein a theoretical longitudinal acceleration (ax_model) is determined as follows in step b):
$$ax\_model = \frac{MA - SumMBrake - MJ\_SUM - MWL}{R * m} ,$$
where MA denotes the drive torque, SumMBrake denotes the sum of the wheel braking torques (MBrake_1, MBrake_2, MBrake_3, MBrake_4), MJ_SUM denotes the sum of the moments of inertia of the wheels (MJ_1, MJ_2, MJ_3, MJ_4), MWL denotes the air resistance moment, R denotes the rolling radius of the wheels, i.e., tires (RVL, RVR, RHL, RHR) and m denotes the mass.

19. The method as recited in one of the preceding claims, wherein detection of wheel spinning is taken into account in step b).

20. The method as recited in one of the preceding claims, wherein a reference gradient (REFGRADIENT) is taken into account in step b).

21. The method as recited in one of the preceding claims, wherein the reference gradient (REFGRADIENT) is selected from a plurality of predefined reference gradient values.

22. A device for implementing the method as recited in one of claims 1 through 21.

23. A system for controlling and/or regulating driving response of a motor vehicle, in particular a vehicle having all-wheel drive, having at least two driven wheels, at least one sensor element of a sensor (SVL, SVR, SHL, SHR) being situated on the wheels, in particular on the wheel bearings, and/or in tires (RVL, RVR, RHL, RHR) assigned to the wheels, and the output signals of the sensors (SVL, SVR, SHL, SHR) being analyzed to control and/or regulate driving response of the vehicle,
wherein the sensors (SVL, SVR, SHL, SHR) detect forces acting on the wheels and/or tires (RVL, RVR, RHL, RHR), and means (10) are provided for determining a reference speed (FZ_REF) representing the longitudinal speed of the vehicle, which is taken into account in controlling and/or regulating driving response, the forces acting on the wheels and/or tires (RVL, RVR, RHL, RHR) being taken into account in determining the reference speed.

24. The system as recited in claim 23, wherein the means for determining the reference speed (FZ_REF) representing the longitudinal speed of the vehicle also take into account wheel speeds (V_VL, V_VR, V_HL, V_HR) detected by the sensors (SVL, SVR, SHL, SHR).

25. The system as recited in one of claims 23 through 24, wherein the wheel speeds (V_VL, V_VR, V_HL, V_HR) detected by the sensors (SVL, SVR, SHL, SHR) are ABS-filtered wheel speeds.

26. The system as recited in one of claims 23 through 25, wherein the means (10) for determining the reference speed (FZ_REF) representing the longitudinal speed of the vehicle determine first PTl-filtered wheel speeds (Van_VL, Van_VR, Van_HL, Van_HR) from the wheel speeds (V_VL, V_VR, V_HL, V_HR) detected by the sensors (SVL, SVR, SHL, SHR).

27. The system as recited in one of claims 23 through 26, wherein the means (10) for determining the reference speed (FZ_REF) representing the longitudinal speed of the vehicle determine second PTl-filtered wheel speeds (VanF_VL, VanF_VR, VanF_HL, VanF_HR) from the wheel speeds (V_VL, V_VR, V_HL, V HR) detected by the sensors (SVL, SVR, SHL, SHR).

28. The system as recited in one of claims 23 through 27, wherein the means (10) for determining the reference speed (FZ_REF) representing the longitudinal speed of the vehicle also take into account wheel accelerations (Avan_VL, Avan_VR, Avan_HL, Avan_HR).

29. The system as recited in one of claims 23 through 28, wherein the means (10) for determining the reference speed (FZ_REF) representing the longitudinal speed of the vehicle also determine wheel accelerations (Avan_VL, Avan_VR, Ava_HL, Avan_HR) from the wheel speeds (V_VL, V_VR, V_HL, V_HR) detected by the sensors (SVL, SVR, SHL, SHR).

30. The system as recited in one of claims 23 through 29, wherein the means (10) for determining the reference speed (FZ_REF) representing the longitudinal speed of the vehicle also take into account the slowest wheel speed (V_1Ref) of the first filtered wheel speeds (Van_VL, Van_VR, Van_HL, Van_HR) as well as the respective wheel acceleration (A_V1Ref).

31. The system as recited in one of claims 23 through 30, wherein the means (10) for determining the reference speed (FZ_REF) representing the longitudinal speed of the vehicle take into account one or more of the following variables: second-slowest wheel speed (V_Second), average vehicle speed of the driven axles (VMAN), greatest positive wheel acceleration (AVAN_max), greatest negative wheel acceleration (AVAN_min), greatest wheel speed (VANmax).

32. The system as recited in one of claims 23 through 31, wherein the means (10) for determining the reference speed (FZ_REF) representing the longitudinal speed of the vehicle and also take into account an unfiltered reference speed (FZ REF_un).

33. The system as recited in one of claims 23 through 32, wherein the means (10) for determining the reference speed (FZ_REF) representing the longitudinal speed of the vehicle assign the value of the greatest wheel speed (VANmax), the value of the slowest wheel speed (V_1Ref) or the value of the average vehicle speed of the driven axles (VMAN) to the unfiltered reference speed (FZ_REF_un) as a function of selected determined variables.

34. The system as recited in one of claims 23 through 33, wherein the means (10) for determining the reference speed (FZ_REF) representing the longitudinal speed of the vehicle take into account the forces acting on the wheels and/or tires (RVL, RVR, RHL, RHR) in the form of wheel pressures via wheel braking torques (MBrake_1, MBrake_2, MBrake_3, MBrake_4) acting on the wheels and/or tires (RVL, RVR, RHL, RHR).

35. The system as recited in one of claims 23 through 34, wherein the means (10) for determining the reference speed (FZ_REF) representing the longitudinal speed of the vehicle determine the wheel braking torques (MBrake_1, MBrake_2, MBrake_3, MBrake_4) by multiplying the wheel pressures times a brake coefficient (cp).

36. The system as recited in one of claims 23 through 35, wherein the means (10) for determining the reference speed (FZ_REF) representing the longitudinal speed of the vehicle take into account the sum (SumMBrake) of the wheel braking torques (MBrake_1, MBrake_2, MBrake_3, MBrake_4).

37. The system as recited in one of claims 23 through 36, wherein the means (10) for determining the reference speed (FZ_REF) representing the longitudinal speed of the vehicle take into account moments of inertia of the wheels (MJ_1, MJ 2, MJ_3, MJ_4) as well as the sum (MJ_SUM) of the moments of inertia of the wheels (MJ_1, MJ_2, MJ_3, MJ_4).

38. The system as recited in one of claims 23 through 37, wherein the means (10) for determining the reference speed (FZ_REF) representing the longitudinal speed of the vehicle take into account a drive torque (MA) which corresponds to the product of an instantaneous engine torque and a transmission and gearshift ratio.

39. The system as recited in one of claims 23 through 38, wherein the means (10) for determining the reference speed (FZ_REF) representing the longitudinal speed of the vehicle take into account an air resistance moment (MWL).

40. The system as recited in one of claims 23 through 39, wherein the means (10) for determining the reference speed (FZ_REF) representing the longitudinal speed of the vehicle determine a theoretical longitudinal acceleration (ax_model) as follows:
$$ax\_model = \frac{MA - SumMBrake - MJ\_SUM - MWL}{R * m} ,$$
where MA denotes the drive torque, SumMBrake denotes the sum of the wheel braking torques (MBrake_1, MBrake_2, MBrake_3, MBrake_4), MJ_SUM denotes the sum of the moments of inertia of the wheels (MJ_1, MJ_2, MJ_3, MJ_4), MWL denotes the air resistance moment, R denotes the rolling radius of the wheels, i.e., tires (RVL, RVR, RHL, RHR) and m denotes the mass.

41. The system as recited in one of claims 23 through 40, wherein the means (10) for determining the reference speed (FZ_REF) representing the longitudinal speed of the vehicle take into account the detection of wheel spinning.

42. The system as recited in one of claims 23 through 41, wherein the means (10) for determining the reference speed (FZ_REF) representing the longitudinal speed of the vehicle take into account a reference gradient (REFGRADIENT).

43. The system as recited in one of claims 23 through 42, wherein the means (10) for determining the reference speed (FZ_REF) representing the longitudinal speed of the vehicle select the reference gradient (REFGradient) from a plurality of predefined reference gradient values.

44. A system for controlling and/or regulating the driving response of a motor vehicle having all-wheel drive and having at least two tires (RVL, RVR, RHL, RHR) and/or two wheels, wherein a force sensor is mounted in the tires (RVL, RVR, RHL, RHR) or on the wheels, in particular on the wheel bearings, and, a reference speed variable (FZ_REF) representing the longitudinal speed of the vehicle is determined as a function of the output signals of the force sensor and this reference speed variable (FZ_REF) is taken into account in controlling and/or regulating the driving response.
